(19) United States
(12) Patent Application Publication
(10) Pub. No.: US 2012/0205101 A1
(43) Pub. Date: Aug. 16, 2012

(54) METHOD FOR MAKING RESIN-COATED PROPPANTS AND A PROPPANT

(76) Inventors: Evgeny Pribytkov, Ekaterinburg (RU); Sergey Pliner, Ekaterinburg (RU); Evgeny Rozhkov, Ekaterinburg (RU); Sergey Shmotev, Ekaterinburg (RU); Vyacheslav Sychev, Ekaterinburg (RU)

(21) Appl. No.: 13/353,778

(22) Filed: Jan. 19, 2012

(30) Foreign Application Priority Data
Jan. 19, 2011 (CA) 2,728,897

(51) Int. Cl. E21B 43/267; B05D 7/00

(52) U.S. Cl. 166/280.2; 427/215

(57) ABSTRACT

A method for making resin-coated proppants comprising applying epoxy and phenol resins with a curing agent onto the surface of proppants. The epoxy and phenol resins with the curing agent are applied onto the surface of the mix of proppants. The mix of proppants is obtained by blending heavy proppants with bulk density of 1.4 g/cm3 and more, with lightweight proppants with bulk density of less than 1.4 g/cm3. The application of the epoxy and phenol resins is performed at temperatures from 5 to 35. degrees Celsius.

### CROSS-REFERENCE TO RELATED APPLICATIONS

This application requests priority on Canadian Patent Application No. 2,728,897 filed on Jan. 19, 2011 and incorporated herein in its entirety.

### FIELD OF THE INVENTION

The invention relates to methods for making curable resin-coated proppants for their use as propping agents in oil and gas wells formed by hydraulic fracturing.

### BACKGROUND OF THE INVENTION

Curable in a well, proppants include a spherical core (glass, ceramics, glass ceramics, silica sand, etc.) and a resin coating. In general, coatings of proppants curable inside the well are composed of phenol-formaldehyde resin, which is not entirely solidified.

After pumping such proppants into the well they are heated up to 50-150 degrees C. (the deeper the well is, the higher the temperatures are) and their coating is polymerized (cured). In the course of the process solid porous bodies are formed through the cavities of which oil would crop out without proppant backflow.

Alongside with maximum crush strength, high sphericity and roundness, as well as minimum bulk density, there are other quality characteristics attributable to resin-coated proppants such as the strength of proppant conglomerates after their polymerization in the well and the temperature at which the strength is gained.

The actual-to-date world manufacturing techniques for resin-coated proppants are significantly based on dry sand processes for hot molding of patterns used in metalware casting. (See A. Knop, W. Scheib, Chemistry and Application of Phenolic Resins. Translation from English, M., the Khimia Publishing House, 1983).

According to said processes, the surface of hot sand (with the temperature ranging from 160 to 220. degrees ^{C}), at intensive mixing, is applied with phenol-formaldehyde resin which is adhered to the surface of the sand and afterwards, the mix is added with a curing agent in the form of an aqueous solution of hexamethylenetetramine. The water from the curing solution is evaporated decreasing the temperature of the system up to 100. degrees C. and the process of polymerization is interrupted, then the resin-coated sand is removed from the mixing device and cooled down at a maximum high rate up to temperatures less than 50. degrees C. Model molding from resin-coated sand is carried out at the temperature of complete polymerization of phenol-formaldehyde resin equal to more than 100. degrees C.

The use of the process has the following drawbacks.

Firstly, the second layer of phenol-formaldehyde resin with a curing agent for a certain time is exposed to high temperatures and partially cured, thus, the making of a high quality conglomerate will require considerable amounts of resin (up to 5% of proppant weight) and will lead to the reduction of “the clear area” between proppants during polymerization in the well under pressure and, correspondingly, to the decrease of permeability of a proppant pack.

Secondly, considerable curing time for resin-coated proppants produced at high temperatures will result in the actual temperature at the initial stage of polymerization in the well exceeding 70 degrees C. while the temperature for the polymerization of the major part of oil beds (shallow and deep) would be within the range of 50-70 degrees C.

Thirdly, “hot” polymerization of phenol-formaldehyde resin is an environmentally hazardous production area and reheating of vapors cannot solve the problem since it contributes to irrational consumption of energy carriers and follow-up release of carbon dioxide into atmosphere.

Therefore to use the dry sand process for the production of resin-coated proppants is not an optimum solution even for deeper wells where the polymerization temperature exceeds 100. degrees. C. The use of resin-coated proppants in shallow and medium-depth wells will cause their carry-over together with oil pushed out or will require the application of special curing catalysts.

Those skilled in the art know US application No. 2008/0230223A1, which discloses a method for making proppants. According to the method, to reduce the coating polymerization (consolidation) temperature, resole phenol-formaldehyde resin solution is applied onto the surface of a proppant as the first layer and after that the surface is covered with powdered phenol-formaldehyde resin and a curing agent. When the solvent from the resole resin solution is evaporated, the dried layer is polymerized and the powder of the outer layer is adhered. The coating is applied and the solvent is removed without any heating, the outer layer is hardly polymerized and depending on resin composition strong conglomerates can be formed by heating at temperature from 65. degrees C. This resin-coated proppant has traditional characteristics which are quite tolerable for the use of such proppant in the medium-depth wells.

The above coating has the following deficiencies:

The evaporation of the considerable amount of the solvent (up to 50% of resin weight) requires the use of huge volumes of air or vacuum, which is quite expensive and complicated in terms of the equipment.

When the solvent is removed the polymer layer will lose up to 80% of its strength and become porous. This phenomenon becomes apparent during proppant polymerization in the well while getting in contact with hot water and with brine, in particular. The water when entering through the coating will tear off the polymer film apart from the surface of a granule, and as a result, the built-up of the film particles will block the oil seepage. After breaking the polymer film the strength of the formed conglomerate will reduce gradually and the probability of the proppant carry-over from the fracture will augment.

Since the resole phenol-formaldehyde resin was not polymerized, so the coating having low-strength adherence to the surface of a granule in case of intensive mechanical impact will be partially removed.

The use of proppants having such coatings is viable only in the wells with operating temperature not less than 65. degrees C.

Also known is a method disclosed in Patent RF No. 2318856, wherein for the purpose of coating an epoxy-phenolic compound is used and, wherein the surface of proppants is initially coated with a layer of epoxy resin and then the coating, which is not consolidated yet, is covered with powdered phenol-formaldehyde resin combined with a curing agent, i.e. a phenol-epoxy coating, which is gradient by its composition, is formed. The distinctive feature of the coating is that depending on the epoxy resin pre-curing conditions, a number of intermediate compositions having different temperatures of complete consolidation can be generated, which allows to use such proppants in any wells regardless of their depth.

The known method for making resin-coated proppants has some disadvantages. When applying viscous epoxy resin onto their surface, the major part of resin will envelope smaller particles and since there is a wide variety in terms of the proppant size distribution (large fractions differ from smaller ones in two or two and a half times), the larger portion of the coating will rest on the surface of a smaller fraction and this will determine the reduced strength of the conglomerate in the well.

### SUMMARY OF THE INVENTION

The invention aims to increase the strength of curable resin-coated proppants when using their conglomerate in the well and to reduce the operational temperature.

The said result can be attained by the known method for making resin-coated ceramic proppants wherein epoxy and phenolic resins in combination with a curing agent are applied onto the surface of the proppants wherein the epoxy and phenol resin are applied onto the surface of the mixed proppants wherein the mixture is formed by blending heavy-weight proppants with bulk density of 1.4 g/cm³ and lightweight proppants with bulk density of less than 1.4 g/cm³ wherein the epoxy and phenol resins are applied onto the surface of the proppants at temperatures of 5-35. degrees C. The ratio of heavy and more lightweight fractions in terms of their average median size is within the range of 1.0-1.3. The ratio of heavy and more lightweight proppants in terms of their bulk volume is within the range of 1.05-1.40. The content of the lightweight proppant fractions as compared to the total quantity of proppants is in the range from 5 to 30%.

The production of resin-coated ceramic proppants is characterized by the above method.

### DESCRIPTION

Feeding epoxy resin with a solvent which reduces viscosity contributes to the formation of homogenous coating but at the same time deteriorates the strength of adherence between the coating and the proppant as well as the coating resistance against water. Moreover, the solvent releases very slowly and as a result during the consolidation of epoxy-phenol compound one can see that the agglomeration is only partial and the resin coating is broken.

The heating of proppants up to 40-50 degrees C. will eradicate the defects however polymerization and formation of stronger conglomerates preventing the carry-over of proppants from the well will take place at temperatures more than 70. degrees C.

All existing blenders (twin-shaft, screw, cone-shaped, etc.) are not able to ensure the homogeneity of proppant granules in terms of their size distribution: in the course of blending, granules are segregated and, as a rule, heavier granules are either oversized (twin-shaft mixers, drum-type mixers) or move faster (screw-type, drum-type mixers) which leads to an unacceptable defractionation of proppants and, as a consequence, to a wider variation of properties among resin-coated proppants from one and the same batch. Proppants disintegration (separation) into close cut fractions will eliminate these shortcomings but the customers will not be satisfied because this is not foreseen by the design of hydraulic fracturing (i.e. fractions by 18/20 or 30/40). Besides, the production of the close cut fractions is not economically advisable for the share of unclaimed proppants (goods with no demand) is enhanced.

During some experiments it was established that by using proppants with different bulk densities we may considerably upgrade the strength of the conglomeration of a pack of proppants wherein the content of proppants with minor density cannot be less than 5% or more than 30%.

To add to the quality characteristics of the curable resin-coated proppants, in the course of the coating application we tried to regulate the ratio between smaller and larger granules of different density which made it possible to considerably eliminate inhomogenuity of the coating by epoxy resin, enhance the strength of the conglomerate in the well in case of hydraulic fracturing, and reduce the operating temperature of the resin-coated proppant.

According to this invention the proppant bulk densities boundary line is 1.4 g/cm³, which was obtained by experiment and conventionally referred to “light” proppants with bulk density less than 1.65 g/cm³. The distinctive feature of the proppant production process is that granules have compact-grained and strong ceramic structures when bulk density equals or exceeds 1.4 g/cm³. If such bulk density is less than the above, i.e. less than 1.4 g/cm³, the structure is less compact-grained and the strength of granules deteriorates. Thus, the proppants can have a coating based on any type of ceramics enabling to produce granules with different bulk densities and porosities.

The process of applying resin coatings is carried out at temperature 5-35 degrees C. in the following sequence:
heavy and lightweight fractions are mixed in a blender;
an epoxy resin is introduced into the blender;
a curing agent for epoxy resin is introduced into the blender;
powdered phenol-formaldehyde resin with a curing agent is introduced into the blender and mixed so that they are distributed homogeneously on the surface of the granules; then the mix is discharged from the blender and remixed in the gravity-assisted device until the epoxy resin is consolidated.

The limited temperature range of 5-35 degrees C. for making a resin-coated proppant primarily relates to the specific nature of consolidation of epoxy resin in the base of epoxy-phenol compound. At temperature less than 5 degrees C. the compound is consolidated for a long time, within 56 hours. The introduction of consolidation promoters would partially solve the problem but at the same time it would produce an adverse effect on operating characteristics. The upper consolidation limit of 35. degrees C. is also determined by the nature of consolidation of epoxy resins. The increase in temperature by more than 35. degrees C. results in the reduced time of making resin-coated proppants, but leads to abrupt deterioration of the strength properties of the proppant conglomerate due to its partial polymerization in the process of manufacture. In the meantime, by regulating resin-coated proppants operational temperature we can establish the bottom limit of their operation, especially when the polymerization temperature of 55 degrees C. is not required. The dependence of the bottom operating limit of resin-coated proppants on the temperature of manufacture for each type of proppants is determined by experiment.

Ceramic magnesium-silicate proppants have different weight by volume. Moreover, their properties differentiate as well, i.e. specific weight and strength of the granule surface layer, specific weight of a granule itself and its strength. The said parameters can exert considerable influence on the surface quality of proppants and their operating characteristics. Correspondingly, the proppant granules with less bulk density have lesser strength and higher porosity.

The granules of proppants having a resin coating with different bulk density: i.e. granules with diameter D₁ have bulk density of 1.6 g/cm³ and granules with diameter D₂ have bulk density of 1.4 g/cm³. When they interact under pressure the stronger granule D₁ would punch the surface layer of less strong granule D₂. As a result of this interaction, the granule D₁ would punch the body of the granule D₂ without breaking it. The granule D₂ is not broken due to the elasticity of the applied resin coating based on epoxy-phenol composition.

For instance, by using the conventional process for applying phenol coat, polymer layers and surface of granules would be destroyed because the polymer layer formed as a result would have higher rigidity and during such type of interaction it would be destroyed on a less compact-grained granule.

The observation of the said interaction between granules with different bulk density enabled to discover a few peculiarities which determine operating characteristics of proppants with curable resin coatings.

One of the peculiarities of these granules is that when interacting both granules have a considerable contact area of polymer layers, which enables granules to gain higher strength of adherence and therefore to increase the strength of the proppant conglomerate at a lower temperature of polymerization. In addition, mechanical adherence of the granules is sufficiently strong due to the fact that a granule with high specific weight would punch a granule with less specific weight, which allows reducing resin-coated proppants operating temperature. This effect is observed for granules of one and the same fractional composition enabling to reduce resin-coated proppant operating temperature without any adverse impact on proppant pack conductivity. The influence of porosity of granules with different bulk density on the strength of resin coatings is typical only for epoxy-phenolic composition. It is caused by the fact that we use liquid epoxy resin, and like any other liquid it penetrates into a compact-grained and porous body in a different way. Proppants with density of more than 1.4 g/cm³ are more compact-grained and less porous than granules with density less than 1.4 g/cm³, so in the course of applying epoxy resin on the mixture of proppants with different density, the resin at the same time would penetrate into the granules at different depth, and the lesser diameter of a granule also plays its role. The lightweight granules are better permeated than those of higher density. As a result, the surface layer is becoming stronger and more resilient, which allows to withstand pressures of hard-grained granules without destruction, thus, enabling to achieve higher permeability for proppant packs.

The following examples serve to illustrate the present invention.

A charge of proppants or a mix of proppants with different density 5 kgs by weight was taken. The said charge was mixed in a blender for 2 minutes, and then the blender was added with 50 grams of the following mix: 85% of epoxy resin [symbol] -20 and 15% of triethylentetramine (TETA), and the mix was blended for 5 minutes. Afterwards, powdered phenol resin with a curing agent (hexamethylenetetramine) was added and mixed for 5 minutes. The ready-made charge was unloaded and mixed for 24 hours until epoxy resin is completely consolidated. Then reference screening was performed and resin-coated porppants were tested.

The adhesion strength of proppants is tested by the following techniques. The experiment is conducted by using metal molds with inner diameter of 25.4 mm; two stamping punches; two nozzles for the feed and removal of 2% KCL aqueous solution; a heating element and a thermocouple. The said mold is filled with a charge of proppants, which is calculated based on the mix density, and allowing to obtain a column (pillar) of granules which is equal to 50±5 mm inside the mold. Then the mold is filled with 2% KCL aqueous solution and placed in the press where the load of 68 kg/cm² is created. After that the mould is heated up to the preset temperature and aged (cured) for 24 hours. After curing a proppant conglomerate is removed from the mold and uniaxial compression test is conducted. According to this method proppants are tested at temperatures of 55. degrees C. and 75. degrees C. The said temperatures are chosen as standard since they enable to simulate operation conditions of resin-coated proppants in real geological environment (each temperature corresponds to the well nominal depth). The most characteristic indicator is the temperature of 55.degrees C. because none of the resin-coated proppants with curable coatings made by conventional technologies of hot cladding is polymerized without adding a promoter.

The operation temperature of resin-coated proppants is not directly related to the polymerization temperature of resin coating. Further resin-coated proppant testing procedure is used to determine the ability to interfere with the proppant carry-over from the fracture. The procedure is carried out as follows: molds are charged with proppants in quantities sufficient to obtain a column of granules of 50±5 mm, then the system is filled with 2% KCL aqueous solution and placed under the press imposing the load of 68 kgs/cm². Then the mold is heated to temperatures 45 degrees C., 50 degrees C., 55 degrees C.; and cured for 24 hours. During the experiment the range of temperatures is decreased to 45 degrees C., 50 degrees C., 55 degrees C. and this relates to the fact that under the suggested engineering solution the operation temperature may be reduced to 45 degrees C. The said temperatures are conventional and designed for the evaluation of resin-coated operation efficiency. Upon the curing, the stamping punches are removed from the molds and a retaining ring of 25.4 mm in diameter and 2.5 mm in thickness is mounted. Such retaining ring is designed to fix a pack of proppants inside the mold. Then the mold is passed through with 2% KCL aqueous solution under the pressure of 1 bar for 12 hours. The temperature of the solution is that that was set in the course of curing. In case of no ring to retain the pack, one can extrude (press out) the proppants from the mold since the smooth walls of the mold are insufficiently adhesive to the pack of proppants. As a result of the experiment, relative loss of weight for the pack of proppants in the mold can be defined, i.e. the proportion of the carried-over resin-coated proppant.

According to the above experiment, samples with different fractional composition were manufactured. The results of the experiment are given in Table 1. The table shows numbers of compositions; ratios of bulk densities for heavy and lightweight proppants [symbol] ; ratios of average median diameters for heavy and lightweight proppants [symbol] ; the content of heavy and lightweight proppants in a base grain. The manufacture of the samples stated in Table 1 was executed at the temperature 25 degrees C.

Table 1 shows the results of the samples testing

| | | | | Adhesion | | Proppant | | |
|---|---|---|---|---|---|---|---|---|
| | | | | strength, | | carry-over, | | |
| | | | | kgs/cm² | | % | | |
| No. | Particle size distribution | [symbol] | [symbol] | 55° C. | 75° C. | 45° C. | 50° C. | 55° C. |
| 1 | 100% fractions 16/30, | — | — | 10.1 | 36.3 | 100 | 63 | 0 |
| | [symbol] = 1.54 r/CM³; | | | | | | | |
| | [symbol] = 0.97 MM. | | | | | | | |
| | (Patent RF No. 2318856) | | | | | | | |
| 2 | 97.5% fractions 16/30, | 1.06 | 1.21 | 12.6 | 38.0 | 96 | 42 | 0 |
| | [symbol] = 1.54 r/CM³; | | | | | | | |
| | [symbol] = 0.97 MM. | | | | | | | |
| | 2.5% proppants | | | | | | | |
| | [symbol] = 1.45 r/CM³; | | | | | | | |
| | [symbol] = 0.80 MM. | | | | | | | |
| 3 | 95% fractions 16/30, | 1.06 | 1.21 | 16.4 | 42.2 | 27 | 6 | 0 |
| | [symbol] = 1.54 g/cm³; | | | | | | | |
| | [symbol] = 0.97 mm. | | | | | | | |
| | 5% proppants | | | | | | | |
| | [symbol] = 1.45 g/cm³; | | | | | | | |
| | [symbol] = 0.80 mm. | | | | | | | |
| 4 | 85% fractions 16/30, | 1.06 | 1.21 | 25.3 | 48.5 | 12 | 1 | 0 |
| | [symbol] = 1.54 g/cm³; | | | | | | | |
| | [symbol] = 0.97 mm. | | | | | | | |
| | 15% proppants | | | | | | | |
| | [symbol] = 1.45 g/cm³; | | | | | | | |
| | [symbol] = 0.80 mm. | | | | | | | |
| 5 | 70% fractions 16/30, | 1.06 | 1.21 | 20.0 | 43.7 | 15 | 2 | 0 |
| | [symbol] = 1.54 g/cm³; | | | | | | | |
| | [symbol] = 0.97 mm. | | | | | | | |
| | 30% proppants | | | | | | | |
| | [symbol] = 1.45 g/cm³; | | | | | | | |
| | [symbol] = 0.80 mm. | | | | | | | |
| 6 | 65% fractions 16/30, | 1.06 | 1.21 | 7.1 | 19.8 | 70 | 25 | 0 |
| | [symbol] = 1.54 g/cm³; | | | | | | | |
| | [symbol] = 0.97 mm. | | | | | | | |
| | 35% proppants | | | | | | | |
| | [symbol] = 1.45 g/cm³; | | | | | | | |
| | [symbol] = 0.80 mm. | | | | | | | |
| 7 | 85% fractions 16/30, | 1.06 | 1.00 | 15.0 | 42.1 | 20 | 4 | 0 |
| | [symbol] = 1.54 g/cm³; | | | | | | | |
| | [symbol] = 0.97 mm. | | | | | | | |
| | 15% proppants | | | | | | | |
| | [symbol] = 1.45 g/cm³; | | | | | | | |
| | [symbol] = 0.97 mm. | | | | | | | |
| 8 | 85% fractions 16/30, | 1.06 | 1.10 | 20.1 | 46.2 | 15 | 1 | 0 |
| | [symbol] = 1.54 g/cm³; | | | | | | | |
| | [symbol] = 0.97 mm. | | | | | | | |
| | 15% proppants | | | | | | | |
| | [symbol] = 1.45 g/cm³; | | | | | | | |
| | [symbol] = 0.88 mm. | | | | | | | |
| 9 | 85% fractions 16/30, | 1.06 | 1.29 | 22.3 | 47.2 | 13 | 1 | 0 |
| | [symbol] = 1.54 g/cm³; | | | | | | | |
| | [symbol] = 0.97 mm. | | | | | | | |
| | 15% proppants | | | | | | | |
| | [symbol] = 1.45 g/cm³; | | | | | | | |
| | [symbol] = 0.75 mm. | | | | | | | |
| 10 | 85% fractions 16/30, | 1.06 | 1.38 | 13.0 | 38.6 | 57 | 20 | 0 |
| | [symbol] = 1.54 g/cm³; | | | | | | | |
| | [symbol] = 0.97 mm. | | | | | | | |
| | 15% proppants | | | | | | | |
| | [symbol] = 1.45 g/cm³; | | | | | | | |
| | [symbol] = 0.70 mm. | | | | | | | |
| 11 | 85% fractions 16/30, | 1.02 | 1.21 | 11.3 | 38.0 | 100 | 57 | 0 |
| | [symbol] = 1.54 g/cm³; | | | | | | | |
| | [symbol] = 0.97 mm. | | | | | | | |
| | 15% proppants | | | | | | | |
| | [symbol] = 1.50 g/cm³; | | | | | | | |
| | [symbol] = 0.80 mm. | | | | | | | |
| 12 | 85% fractions 16/30, | 1.23 | 1.21 | 30.9 | 55.4 | 8 | 0 | 0 |
| | [symbol] = 1.54 g/cm³; | | | | | | | |
| | [symbol] = 0.97 mm. | | | | | | | |
| | 15% proppants | | | | | | | |
| | [symbol] = 1.25 g/cm³; | | | | | | | |
| | [symbol] = 0.80 mm. | | | | | | | |
| 13 | 85% fractions 16/30, | 1.38 | 1.21 | 20.8 | 40.7 | 9 | 0 | 0 |
| | [symbol] = 1.54 g/cm³; | | | | | | | |
| | [symbol] = 0.97 mm. | | | | | | | |
| | 15% proppant | | | | | | | |
| | [symbol] = 1.11 g/cm³; | | | | | | | |
| | [symbol] = 0.80 mm. | | | | | | | |
| 14 | 85% fractions 16/30, | 1.47 | 1.21 | 5.0 | 28.6 | 85 | 31 | 3 |
| | [symbol] = 1.54 g/cm³; | | | | | | | |
| | [symbol] = 0.97 mm. | | | | | | | |
| | 15% proppant | | | | | | | |
| | [symbol] = 1.05 g/cm³; | | | | | | | |
| | [symbol] = 0.80 mm. | | | | | | | |

In Table 1 examples No. 1,2,3,4 and 6 show the influence of the additive of lightweight proppants with bulk density of 1.45 g/cm³ to the base grain of heavy proppants on the quality properties of resin-coated proppant with a curable coating. When introducing lightweight proppants in quantity of 5% (example 2) of the mix weight, quality properties are improved but only slightly. This is explained by insufficient quantity of contacts between heavy and lightweight proppants for the increase of the pack strength and the prevention of carry-over. By increasing the content of lightweight particles from 5 to 30% (examples No. 3,4,5), the quantity of contacts is getting bigger to increase the proppant pack strength. When increasing the content of granules of lightweight proppant fraction for more than 30% (example No. 6), the strength of the proppant pack drops suddenly because the total strength of the mix is becoming low due to the increased number of contacts between granules of lightweight particles.

In Table 1, examples No. 4,7,8,9 and 10, show the influence of the average median diameter of lightweight particles in a mix on the quality properties of a resin-coated proppant. The influence of the average median diameter of proppant lightweight pellets also relates to the number of contacts with proppant heavyweight pellets. When the ratio of median diameters for lightweight and heavyweight pellets is equal (example No. 7), the interaction between the granules—increasing the strength of the pack—is quite intense.

When the median diameter of the proppant lightweight fraction granules is getting smaller, the geometry of the proppant pack build-up will change allowing to improve the intensity of interaction between pellets. As can be seen from examples No. 4,8,9 it will be possible to reduce the operation temperature of the use of resin-coated proppants notwithstanding polymerization of the coating itself. Further decrease in the average-median size of lightweight proppant pellets beyond the established limits (example No. 10) will lead to the sharp reduction of interaction intensity for the number of contacts will drop.

In Table 1, examples No. 4,11,12,13 and 14 show the influence of the ratio of heavy and lightweight fraction bulk densities on the quality properties of a resin-coated proppant. At a ratio less than 1.05 (example No. 11), the difference in densities between pellets is not sufficient for a more dense pellet to enter a less dense pellet. Thus, neither the area of the contact between pellets will grow nor the mechanical link will form. When augmenting the ratio of densities over 1.05 (examples No. 4, 12,13), more dense pellets would punch less dense pellets at quite a depth, consequently it allows to increase the strength of the proppant pack and to decrease the operation temperature. When the ratio increases for more than 1.4 (example 14), lightweight fraction density decrease will lead to a considerable drop in its strength and in this case resin coatings will not stop pellets/granules from destruction, thus, the strength of the pack will be reduced and the resin-coated proppant carry-over will be increased.

Table 2 shows the dependence of basic properties of samples of polymer-coated proppants No. 4 acc.to Table 1 made at temperatures 5 degrees C., 25 degrees C., 35 degrees C. and 55 degrees C.

TABLE 2
Sample basic properties dependence

| | | | Adhesion | | Proppant | | |
|---|---|---|---|---|---|---|---|
| | | | strength | | carry-over | | |
| | | Sampling | kgs/cm² | | % | | |
| No. | Particle composition | temperature, ° C. | 55° C. | 75° C. | 45° C. | 50° C. | 55° C. |
| 1 | Sample No. 4 | 5 | 26.2 | 48.8 | 11 | 1 | 0 |
| | acc. to Table 1. | | | | | | |
| 2 | Sample No. 4 acc. to | 25 | 25.3 | 48.5 | 12 | 1 | 0 |
| | Table 1. | | | | | | |
| 3 | Sample No. 4 acc. to | 35 | 24.1 | 47.0 | 14 | 2 | 0 |
| | Table 1. | | | | | | |
| 4 | Sample No. 4 acc. to | 55 | 4.6 | 35.0 | 100 | 100 | 85 |
| | Table 1. | | | | | | |

Table 2 serves to show the influence of the temperature of manufacturing a curable resin-coated proppant on its quality features. The manufacture of resin-coated proppants at temperatures less than 5 degrees C. is possible but technologically, not justified, because the duration of epoxy resin polymerization within the compound will be increased and will last for 3-5 days. Temperature from 5 to 35 degrees C. is optimal for the consolidation of epoxy resin within the compound, in addition the initialization of phenolicresin polymerization does not take place. When the temperature is more than 35 degrees C., the rate of epoxy resin consolidation will increase but at the same time the process of phenolic resin polymerization will begin within the compound leading to the reduction of “activity” of a resin coating at low temperatures.

Therefore, the strength of curable resin-coated proppants—when their conglomerate is used in the well—will increase, and the operation temperature in the well will be lower than that which is known to those skilled in the art.

1. A method for making resin-coated proppants comprising: applying epoxy and phenol resins with a curing agent onto the surface of proppants, wherein the epoxy and phenol resins with the curing agent are applied onto the surface of the mix of proppants, which is obtained by blending heavy proppants with bulk density of 1.4 g/cm³ and more, with lightweight proppants with bulk density of less than 1.4 g/cm³, where the application of the epoxy and phenol resins is performed at temperatures from 5 to 35. degrees Celsius.

2. The method according to claim 1, wherein the ratio between the average median size of heavy fractions and more lightweight proppant fractions is within the range of 1.0-1.3.

3. The method according to claim 1, wherein the ratio of bulk densities between heavy and more lightweight proppant fraction is within the range of 1.05-1.40.

4. The method according to claim 1, wherein the content of lightweight proppant fraction is within the range of 5-30% of the total amount of the mix.

5. The proppant with a resin coating, wherein such proppant is produced by method according to claim 1.
